(19) United States
(12) Patent Application Publication
(10) Pub. No.: US 2021/0288991 A1
(43) Pub. Date: Sep. 16, 2021

(54) SYSTEMS AND METHODS FOR ASSESSING SOFTWARE VULNERABILITIES THROUGH A COMBINATION OF EXTERNAL THREAT INTELLIGENCE AND INTERNAL ENTERPRISE INFORMATION TECHNOLOGY DATA

(71) Applicant: Cyber Reconnaissance, Inc., Tempe, AZ (US)

(72) Inventors: Paulo Shakarian, Tempe, AZ (US); Jana Shakarian, Tempe, AZ (US); Mohammed Almukaynizi, Tempe, AZ (US); Malay Shah, Tempe, AZ (US)

(21) Appl. No.: 17/201,762

(22) Filed: Mar. 15, 2021

Related U.S. Application Data
(60) Provisional application No. 62/989,465, filed on Mar. 13, 2020.

(51) Int. Cl. H04L 29/06; H04L 12/24

(52) U.S. Cl. CPC H04L 63/1433; H04L 63/1466; H04L 41/16; H04L 63/20; H04L 63/1416

(57) ABSTRACT

Computer-implemented methods and systems for assessing software vulnerabilities through a combination of external threat intelligence and internal information technology data are disclosed.

### CROSS REFERENCE TO RELATED APPLICATIONS

The present application claims benefit to U.S. provisional patent application Ser. No. 62/989,465, filed on Mar. 13, 2020, which is incorporated by reference in entirety.

### FIELD

The present disclosure generally relates to predictive cyber technologies; and in particular, to systems and methods for predicting and/or assessing software vulnerabilities through a combination of external threat intelligence and internal information technology data.

### BACKGROUND

Most of the existing commonly used tools and methods for cybersecurity focus on detecting malicious attacks after they had approached the computing system that is being defended. However, a few other tools use techniques to predict malicious cyber-attacks before they are launched. Most of these approaches are totally based on the activity of hackers in the hacking community websites, such as hacker activity in the Dark and Deep web (collectively, “D2web”). The D2web is a part of the internet that is not indexed by regular search engines or public DNS providers. Dark web sites of the D2web are only accessible through clients that use hidden service protocols like Tor. These protocols are designed to preserve the anonymity and location of clients and servers. The Deep web is a collection of sites that are not indexed nor publically accessible. Unlike the Dark web, only authorized users can access Deep web sites via regular Web browsers.

A software vulnerability is a plurality of flaws or weaknesses present in a software product. Often, such vulnerabilities are unintentionally made by the software developers during the software design and implementation phases. Malicious hackers can exploit vulnerabilities to gain unauthorized access or cause damage to the vulnerable systems; i.e., violating policies related to confidentiality, integrity, or availability of the attacked system. In doing so, hackers use weaponized exploits: pieces of software or chucks of data that use the vulnerability as an entry point to attack the target system. There are different ways to protect a system against exploits, such as patching vulnerabilities or deploying other risk mitigation measures. Risk mitigation measures may include activities such as closing unnecessary open ports (network communication endpoints) in public-facing hosts and deploying firewalls. Patching vulnerabilities is the ideal way to protect against exploits. However, it is extremely difficult to patch all vulnerabilities promptly because the number of software vulnerabilities that are discovered and publicly disclosed is drastically increasing. For example, in 2016 alone, more than 6,000 software vulnerabilities were disclosed in the National Vulnerability Database (NVD), a reference vulnerability database maintained by the National Institute of Standards and Technology (NISD). This number has never fallen below 14,000 vulnerabilities per year.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1A is a simplified block diagram showing a computer-implemented system for assessing software vulnerabilities through a combination of external threat intelligence and internal information technology data.

FIG. 1B is a simplified block diagram of a first embodiment of the system of FIG. 1A.

FIG. 1C is a simplified block diagram of a possible computer-implemented method of applying aspects of the system of FIG. 1A for assessing software vulnerabilities through a combination of external threat intelligence and internal information technology data.

FIG. 2A is a simplified block diagram illustrating aspects of a second embodiment of the system of FIG. 1A.

FIG. 2B is a skyline graph related to the second embodiment of FIG. 2A.

FIG. 3A is a simplified block diagram illustrating aspects of a third embodiment of the system of FIG. 1A.

FIG. 3B is a screen shot of a Nmap scan done on a system which has a windows remote desktop port open for illustrating aspects of the third embodiment of FIG. 3A.

FIG. 4 is a simplified block diagram illustrating aspects of a fourth embodiment of the system of FIG. 1A.

FIG. 5 is a simplified block diagram illustrating aspects of a fifth embodiment of the system of FIG. 1A.

FIG. 6 is a simplified block diagram illustrating aspects of a sixth embodiment of the system of FIG. 1A.

FIG. 7 is a simplified block diagram of a possible computer-implemented method of applying aspects of the system of FIG. 1A including various embodiments and sub-embodiments for assessing software vulnerabilities through a combination of external threat intelligence and internal information technology data.

FIG. 8 is an example simplified schematic diagram of a computing device that may implement various methodologies described herein.

Corresponding reference characters indicate corresponding elements among the view of the drawings. The headings used in the figures do not limit the scope of the claims.

### DETAILED DESCRIPTION

Aspects of the present disclosure relate to a computer-implemented system and associated methods for assessing software vulnerabilities through a combination of external threat intelligence and internal enterprise information technology data. In some embodiments, the systems and methods leverage data elements from: (1) external threat intelligence about software vulnerabilities and hacking activity from a plurality of sources including hacking community websites in D2web sites, hacking discussions in social media websites, and hacking/vulnerability-related posts on Web blogs, and (2) information technology event logs that record network communications data to the hardware devices and the software products that are deployed within a plurality of enterprises. In some systems and methods, data from the aforementioned broad sources are aligned for assessing the risk level associated with vulnerable computing systems within a plurality of enterprises.

### Definitions

Common Vulnerabilities and Exposures (CVE) is a unique identifier assigned to each software vulnerability reported in the NVD. The CVE numbering system follows one of these two formats:

CVE-YYYY-NNNN
CVE-YYYY-NNNNNNN

Where the “YYYY” indicates the year in which the software flaw is reported, and the N's is an integer identifies a flaw (e.g., CVE-2018-4917¹ and CVE-2019-9896²). ¹ https://nvd.nist.gov/vuln/detail/CVE-2018-4917² https://nvd.nist.gov/vuln/detail/CVE-2019-9896

Common Platform Enumeration (CPE) is a list of software/hardware products that are vulnerable to a given CVE. CVE and the respected platforms that are affected, i.e., CPE data can be obtained from the NVD. For example, the following CPE's are some of the CPE's vulnerable to CVE-2018-4917:

cpe:2.3:a:adobe:acrobat_2017:*:*:*:*:*:*:*:*

cpe:2.3:a:adobe:acrobat_reader_dc:15.006.30033:*:*:*:classic:*:*:*

cpe:2.3:a:adobe:acrobat_reader_dc:15.006.30060:*:*:*:classic:*:*:*

Common Vulnerability Scoring System (CVSS) is a numerical score capturing the severity level of software vulnerabilities based on the technical characteristics such as the ease of exploitation and an approximation of impact it would leave if it is exploited. CVSS ranges from 0 to 10 (the most severe score).

A Software stack (inventory) is a collection of software products installed on a computer host (to include public-facing server, cloud instances, endpoint machines, etc.). Such stack can be obtained by different ways. For example, a list maintained by the system administrators indicting what software is on each host, a computer database storing such information, a piece of software that can identify the software stack on a given host such as “wmic product get name, version” on Microsoft Windows, AWS System Manager, etc.

Below are two examples of software stacks:

1. A software stack identified by AWS System Manager:

TABLE 1
Software stack identified from AWS inventory

| Product | Version |
|---|---|
| bzip2 | 1.0.6-8 |
| curl | 7.47.0 |

2. A software stack identified by the wmic tool on Microsoft Windows 10 computer system:

TABLE 2
Software stack identified from wmic on Windows

| Product | Version |
|---|---|
| Adobe Acrobat Reader DC | 19.010.2009 |
| PuTTY release 0.70 | 0.70.0. |
| Microsoft Visual C++ 2005 | 8.0.6100 |
| Redistributable | |
| Java 8 Update 191 (64-bit) | 8.0.1910.1 |

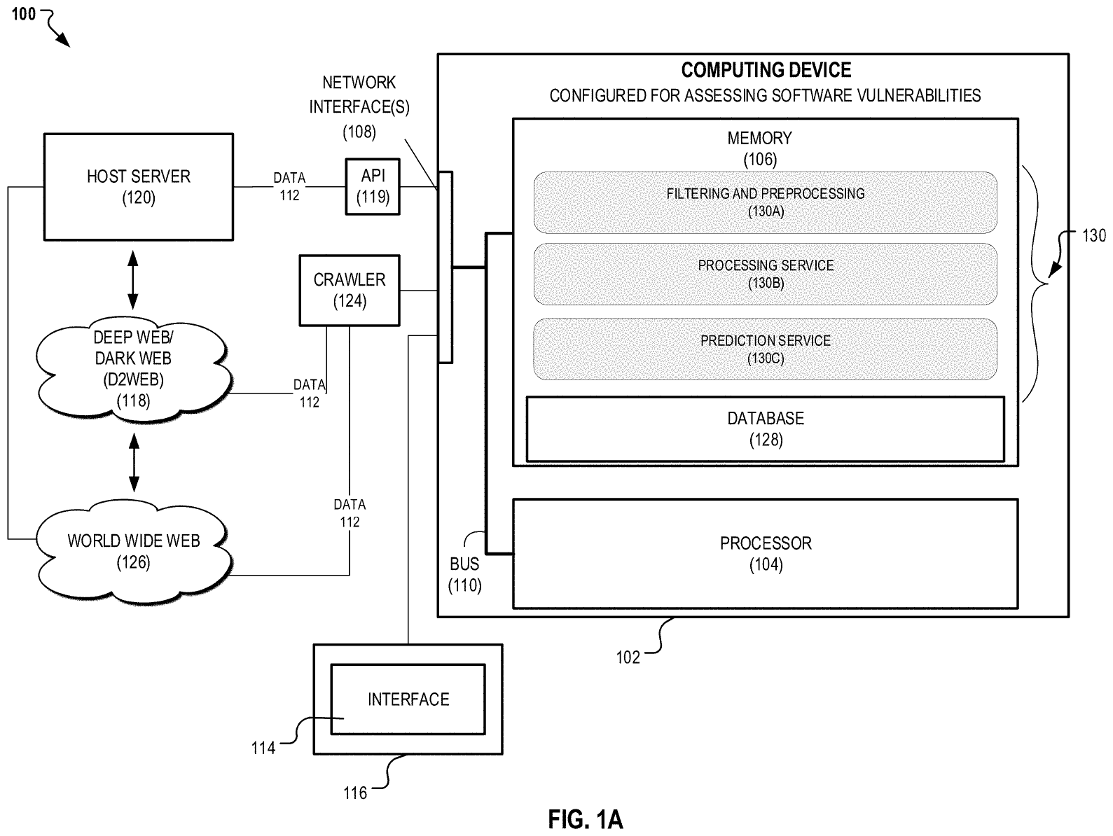

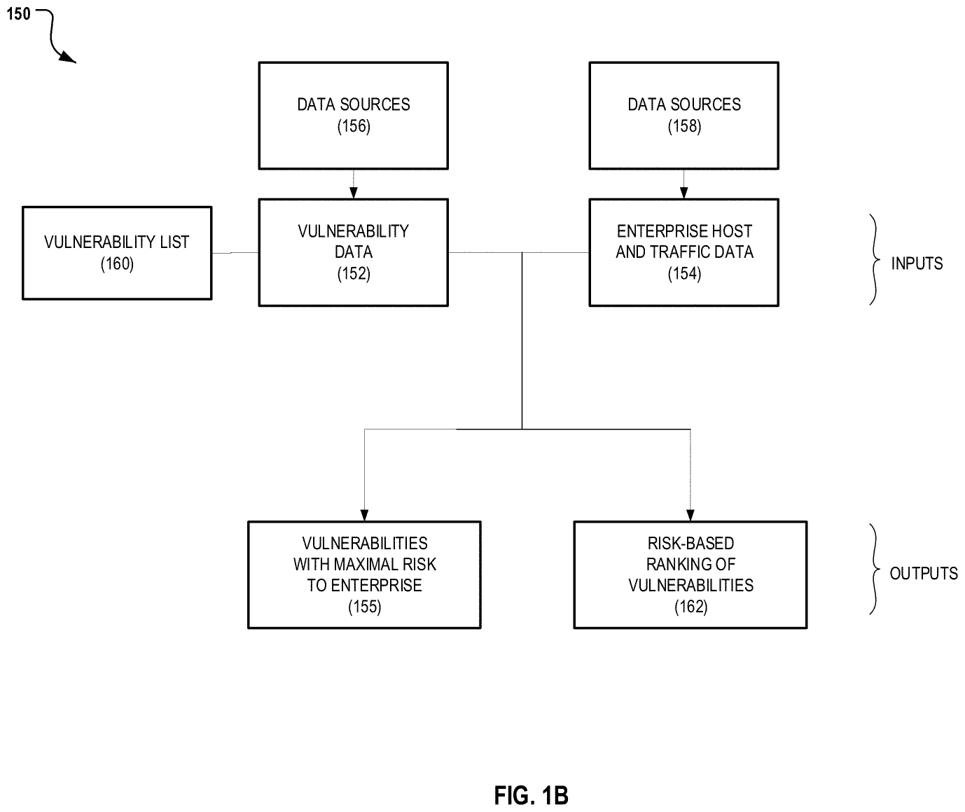

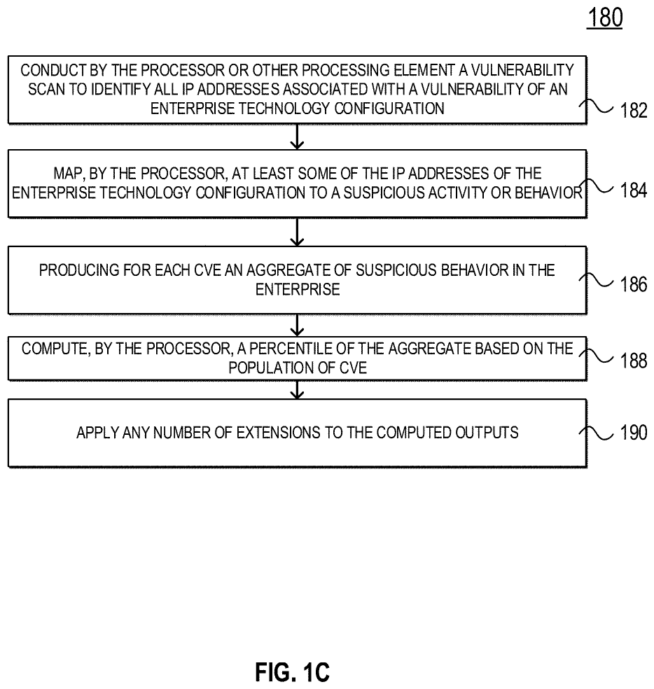

Referring to FIG. 1A, any of the aforementioned embodiments of a system described herein may take the form of a computer-implemented system, designated system 100, which may be utilized for assessing software vulnerabilities through a combination of external threat intelligence and internal information technology data. In general, the system 100 comprises a computing device 102 including a processor 104, a memory 106 of the computing device 102 (or separately implemented), a network interface (or multiple network interfaces) 108, and a bus 110 (or wireless medium) for interconnecting the aforementioned components. The network interface 108 includes the mechanical, electrical, and signaling circuitry for communicating data over links (e.g., wires or wireless links) within a network (e.g., the Internet). The network interface 108 may be configured to transmit and/or receive data using a variety of different communication protocols, as will be understood by those skilled in the art.

As indicated, via the network interface 108 or otherwise, the computing device 102 is adapted to access external threat intelligence and internal enterprise information technology data (hereinafter data 112). In some embodiments, aspects of the data 112 may be retrieved from a host server 120 having information stored/aggregated within a storage device (not shown) or locally stored within the memory 106. The data 112 may originate from sources including the deep web, dark web, social media, open Internet and/or private or proprietary data sources (e.g., enterprise IT environments).

As shown, the computing device 102 is adapted, via the network interface 108 or otherwise, to access the data 112 from any number or type of sources (such as the deep or dark web (D2web) 118). In some embodiments, the computing device 102 accesses the data 112 by engaging an application programming interface 119 to establish a temporary communication link with the host server 120. Alternatively, or in combination, the computing device 102 may be configured to implement a crawler 124 (or spider or the like) to extract data from the data sources without aid of a separate device (e.g., host server 120). Further, the computing device 102 may access the data 112 from the general Internet or World Wide Web 126 as needed, with or without aid from the host server 120.

The data 112 may define any number of datasets and may be aggregated or accessed by the computing device 102 and further may be stored within a database 128. The data 112 may further include any number or type of datasets, attributes, parameters, or other data structures associated with cyber-attack, hacker communications, geolocation information, network traffic logs, information from the NISD, information linking historical cyber events to specific vulnerabilities and associated hardware and software, and the like; identifiable after preprocessing the data 112 or by feature extraction or otherwise.

Once the data 112 is accessed and/or at least temporarily stored in the database 128, the processor 104 is operable to execute a plurality of services 130 to process the data 112, apply the data 112 to any number of predetermined functions, apply machine learning or other forms of artificial intelligence to the data 112 (e.g., extract features) to otherwise leverage the data 112 so as to determine correlations and generate rules or predictive functions, as further described herein. The services 130 of the system 100 may include, without limitation, a filtering and preprocessing service 130A for, in general, preparing the data 112 for machine learning or further use, a processing service 130B, and a prediction service 130C that predicts stages of an attack and aligns source data with other data points for identification of sources of risk such as software vulnerabilities, as further described herein. The plurality of services 130 may include any number of components or modules executed by the processor 104 or otherwise implemented. Accordingly, in some embodiments, one or more of the plurality of services 130 may be implemented as code and/or machine-executable instructions executable by the processor 104 that may represent one or more of a procedure, a function, a subprogram, a program, a routine, a subroutine, a module, an object, a software package, a class, or any combination of instructions, data structures, or program statements, and the like. In other words, one or more of the plurality of services 130 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 106), and the processor 104 performs the tasks defined by the code.

As shown, the system 100 may further provide a portal or interface (e.g., 114) executable by a remote computing device (e.g., computing device 116) that may be leveraged to assess software vulnerabilities through a combination of external threat intelligence and internal enterprise information technology data. The system 100 may include any number or type of devices to provide some external access to the data 112 post processing and to assess software vulnerabilities through a combination of external threat intelligence and internal enterprise information technology data. Multiple embodiments of the system 100 are contemplated, as set forth herein.

### Embodiments of System 100 and Associated Methods for Assessing Software Vulnerabilities

First embodiment of System 100: Referring to FIG. 1B, a first embodiment 150 of the system 100 is shown. In the embodiment 150, the computing device, namely, the processor 104, is configured with computer-executable instructions for aligning vulnerability data with enterprise host and network traffic information for understanding ongoing threats to vulnerabilities. In this embodiment 150, vulnerability data 152 is aligned with enterprise host and network traffic data 154 to understand which vulnerabilities pose the most risk (vulnerabilities with maximal risk to an enterprise 155). In other words, the input to this embodiment 150 system includes:
the vulnerability data 152 for vulnerabilities that exist in the enterprise (may be extracted in the same or similar manner in which the data 112 is accessed); and
the enterprise host and network traffic data 154. This information may be derived from or comprise a repository of suspicious host and/or network data associated with the enterprise.

The vulnerability data 152 may be obtained from a plurality of sources 156 and accessible to the processor 104 of the system 100, and may include but is not limited to:
Vulnerability scanning tools (e.g., Nessus and Qualys);
Software Penetration testing tools (e.g., Metasploit); and
Vulnerabilities identified by cybersecurity human experts.

In some sub-embodiments, the processor 104 is operable to generate or construct a vulnerability list 160 from the vulnerability data 152. The vulnerability list 160 delineates vulnerabilities on each host and computing network and each vulnerability be identified by its CVE number.

Suspicious host and/or network data from the enterprise may be identified or otherwise accessed from data sources 158 including a plurality of cybersecurity systems, such as but not limited to:
Firewall systems,
Intrusion detection systems, and/or
Antivirus systems.

One output of the embodiment 150 of the system 100 includes a risk-based ranking of vulnerabilities 162, hosts, and/or software products based on the enterprise network traffic data.

Referring to FIG. 1C, in one sub-embodiment shown by process 180, the vulnerability data 152 may be aligned with the enterprise host and network traffic data 154, and the processor may access such aligned data and execute the illustrated functions of process 180. For example, in block 182 of process 180, for each vulnerability in a scan of an enterprise (technology configuration including software and/or hardware), all IP addressed associated with the vulnerability is identified. As indicated in block 184, the IP addresses may be mapped to suspicious behavior.

In block 186, the result of the mapping in block 184 is producing, for each CVE, an aggregate of suspicious behavior in the enterprise. Once complete for all vulnerabilities, the percentile of the aggregate based on the population of CVE can be computed.

As further indicated in block 190 of FIG. 1C, the process 180 includes various possible extensions:
Aggregates over abnormal behavior could be binary (presence or absence of)
Aggregates could use something like a Gini index (i.e. higher value if a small portion of endpoints has the suspicious behavior)—this would help to identify if just one was compromised
Note that vulnerability can be broadly defined (not necessarily CVE's)
The same procedure can be done for CPE's (i.e. the software running on the hosts)

### Further Examples and Explanation

To further illustrate, as shown in Table 3 below, the exemplary IP Addresses ‘149.171.126.10’, ‘149′171′126.11’ and ‘149′171′126.12’ of a given enterprise are identified to have had suspicious activity observed from the network traffic coming to and/or originating from them.

TABLE 3
IP Address illustrating IP address suspicious activity

| | | Aggregate | |
|---|---|---|---|
| | | Volume | Percentage |
| | | of Suspicious | of |
| | IP Address | Traffic | suspicious |
| Vulnerability | Associated | (in Megabyte) | traffic |
| CVE-2013-0209 | {‘149.171.126.12’} | 31.55 | 48.5 |
| CVE-2006-0150 | {‘149.171.126.10’, | 61.99 | 77.9 |
| | ‘149.171.126.14’, | | |
| | ‘149.171.126.12’} | | |
| CVE-2014-0322 | {‘149.171.126.10’, | 109.16 | 70.41 |
| | ‘149.171.126.11’, | | |
| | ‘149.171.126.13’, | | |
| | ‘149.171.126.16’} | | |

### Second Embodiment of System 100

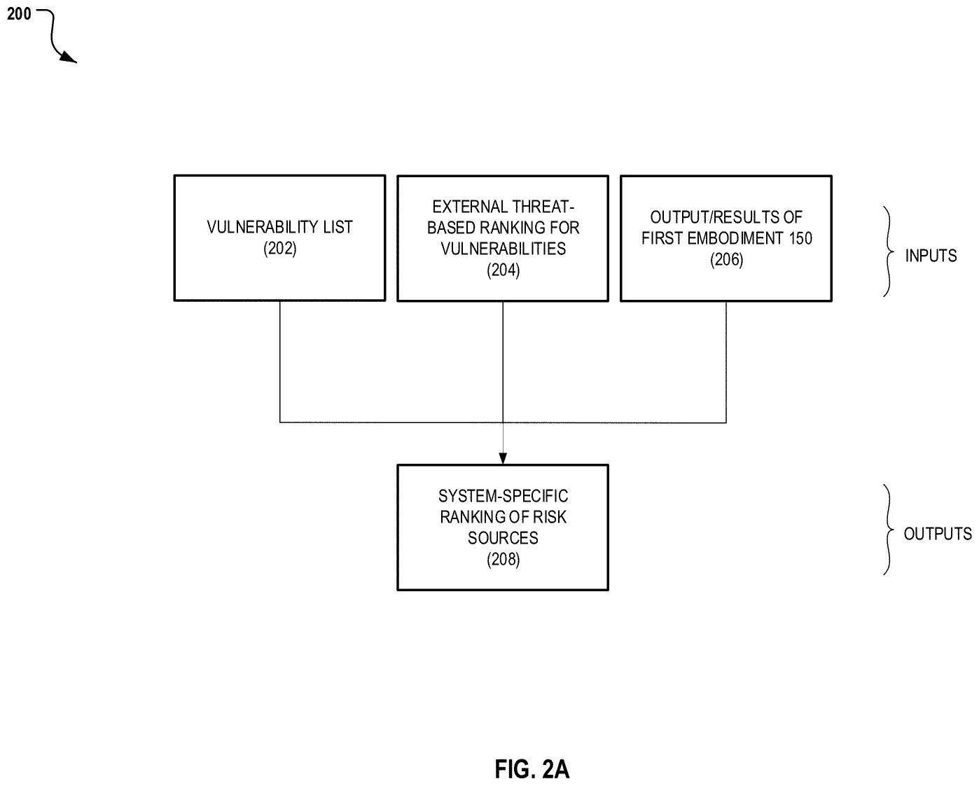

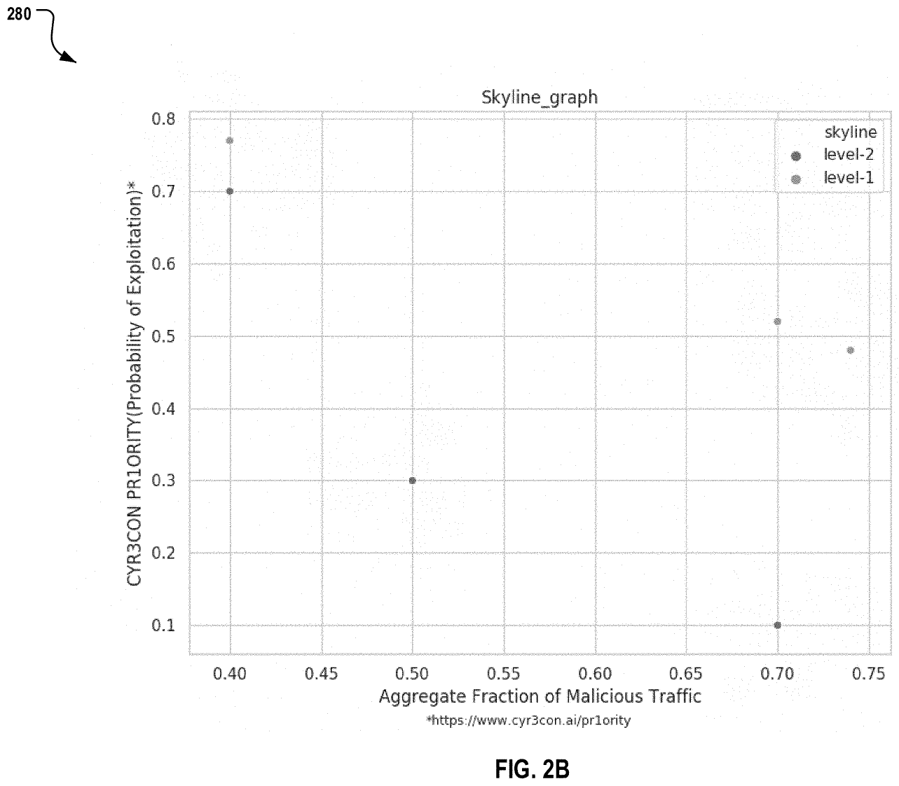

Referring to FIG. 2A, a second embodiment 200 of the system 100 is shown. In the second embodiment 200, the computing device, namely, the processor 104, is configured with computer-executable instructions for identifying high priority vulnerabilities by combining external threat intelligence and internal enterprise it information. This embodiment 200 of the system 100 extends upon the first embodiment 150 by combining external threat intelligence data with the results of the first embodiment 150 to prioritize the vulnerabilities that (1) are associated with IP addresses experiencing heavy suspicious traffic, and (2) have higher risk of being targeted by malicious hackers.

The input to the second embodiment 200 of the system 100 includes:
Vulnerability list (202); and
External threat-based ranking for vulnerabilities (204), such as:
   CYR3CON PRIORITY
   CYR3CON PREVAL
   CVSS score
   Any combination of any threat-based vulnerability ranking systems; and
the output/results (206) of the first embodiment 150.

The output of the second embodiment 200 of the system 100 includes a system-specific ranking of risk sources 208, such as vulnerabilities, hosts, and/or software products based on both network traffic data and external threat-based vulnerability ranking systems.

Vulnerabilities, hosts, and/or software products may be ranked according to the specifications of the second embodiment 200 as in the following non-limiting ways:
Normalize both ranking for the first embodiment 150 and external threat-based ranking by percentile over all CVE's, hosts, and/or software products
Identify all CVE's, hosts, and/or software products on the skyline of a 2 dimensional scatter plot of the two systems
CVE's, hosts, and/or software products can also be ranked in layers:
   Layer 1: Skyline as described above
   Layer 2: New skyline after skyline of layer 1 is removed
   Layer n: New skyline after skyline of layers 1 . . . n−1 are removed
Other methods may be leveraged to combine the two types of scores other than skyline query, for example:
   Grouping CVE's, hosts, and/or software products into risk groups based on the scoring from embodiment 150 and the external threat-based ranking systems following some logical statements with conditions such as equality and inequality checks.
   Ranking CVE's, hosts, and/or software products based on some weighted summation of scores computed based on the external threat intelligence and the enterprise traffic data.

Referring to FIG. 2B, extending the example set out in the first embodiment 150, and after adding probability scores associated with external threat-based ranking (from, e.g., CYR3CON PRIORITY) and comparing the aggregate scores of malicious traffic, the depicted skyline graph 280 shown can be generated by the processor 104. There are 6 examples of CVEs which are included in the skyline graph 280. The points with the orange dots are the ones which are included in the first embodiment 150 table, or Table 3. The blue points are not included in the table because of the low volume of malicious traffic that is level-2 skyline.

| | | Aggregate | CYR3CON |
|---|---|---|---|
| | | fraction of | PRIORITY |
| | IP Address | malicious | (Probability of |
| Vulnerability | Associated | traffic | exploitation) |
| CVE-2013-0209 | {‘149.171.126.12’} | 0.48 | 0.74 |
| CVE-2006-0150 | {‘149.171.126.10’, | 0.77 | 0.40 |
| | ‘149.171.126.14’, | | |
| | ‘149.171.126.12’} | | |
| CVE-2014-0322 | {‘149.171.126.10’, | 0.52 | 0.70 |
| | ‘149.171.126.11’, | | |
| | ‘149.171.126.13’. | | |
| | ‘149.171.126.16’} | | |

### Third Embodiment of System 100

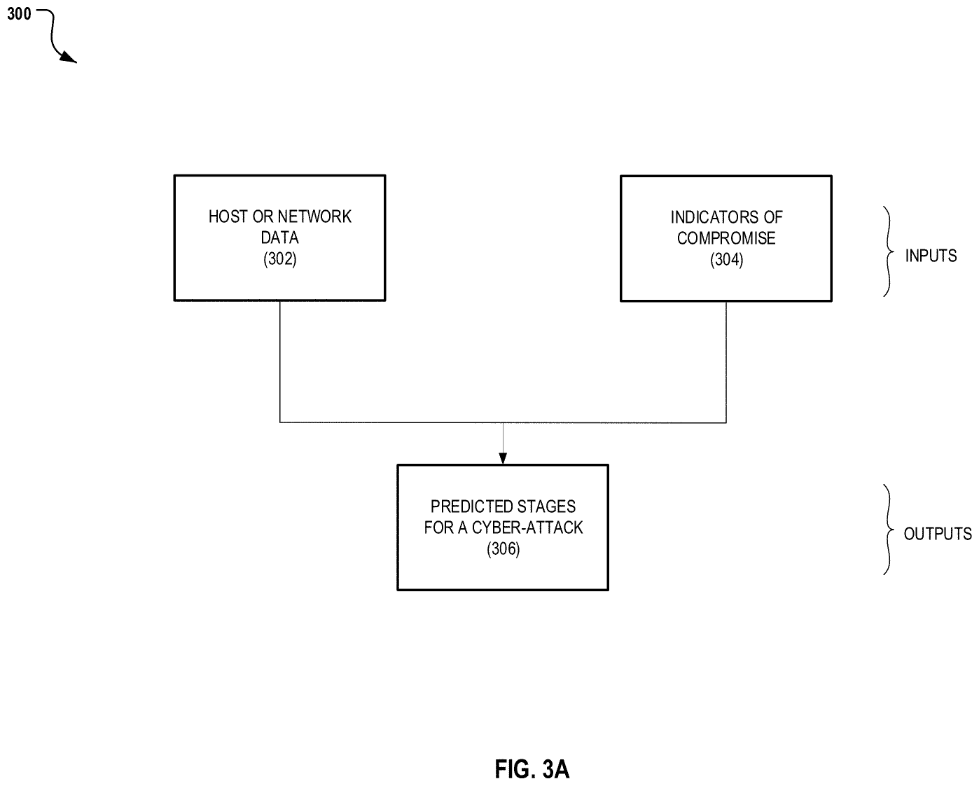

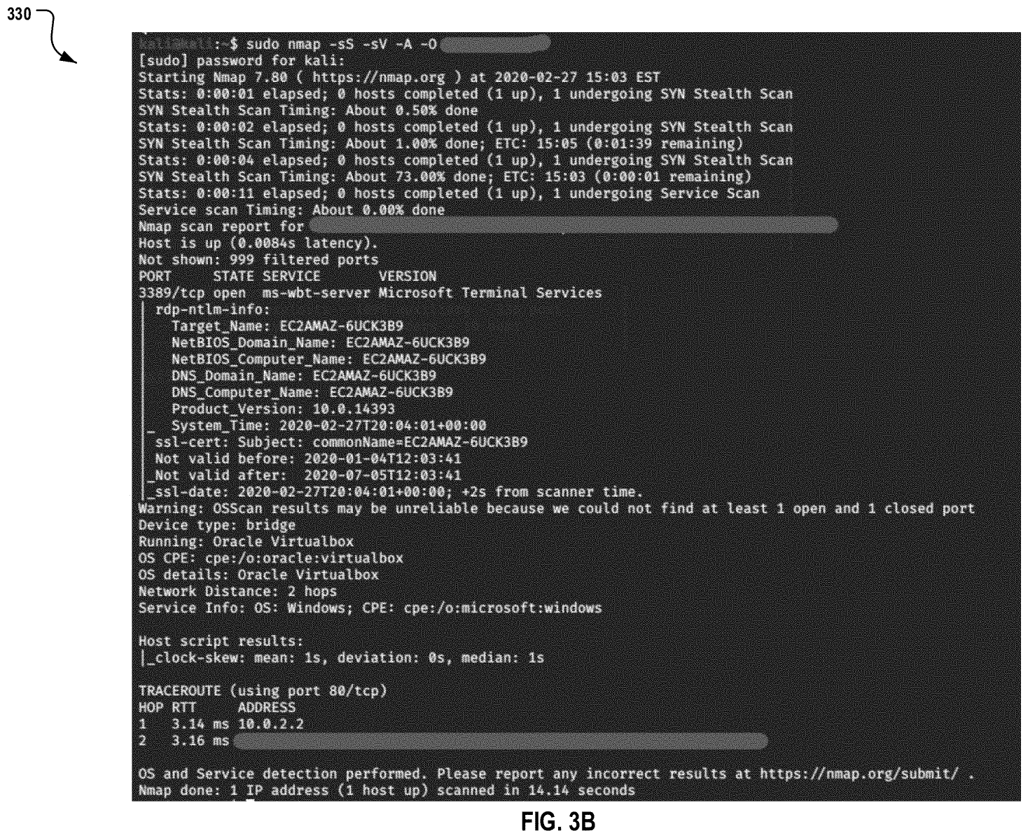

Referring to FIG. 3A, in a third embodiment 300 of the system 100, the computing device 102, namely, the processor 104, is configured with computer-executable instructions for predicting stages of a cyber-attack. Malicious hackers often conduct a series of steps to compromise the target systems. These steps are often called “stages of attacks”. For example, a hacker may need to identify which services are running on the victim's infrastructure so they may guess which vulnerabilities exist, then craft exploits and payloads in accordance. Embodiment 3 shows a concrete example of this attack steps.

Referring to FIG. 3B, attack steps for the BlueKeep vulnerability for Microsoft Windows is demonstrated and explained as follows:
1. First step for infiltrating a victim's system is reconnaissance. This can be done using tools such as Nmap. As demonstrated in FIG. 3B, a screen shot of a Nmap scan done on a system which has a windows remote desktop port open.
2. After knowing that a remote desktop service is enabled on the victim's system, the malicious hacker can look for vulnerabilities in the ExpoitDB which relates to Windows RDO. In the present case, the BlueKeep vulnerability is available on Metasploit and ExploitDB.
3. For this exploit, the victim's interaction is not needed for the vulnerability to be exploited. Using Metasploit, the hacker can send malicious packets to the open port on the victim's system.
4. After the vulnerability is deployed in the system, the hacker creates a backdoor into the victim's system using a small piece of shellcode to increase the privilege.

This third embodiment 300 of the system 100 allows the defender to use host and network traffic data, combined with external threat-based intelligence, to predict stages for attacks (306), and then prioritize which defense measures to deploy first.

Input/s:
Host or network data (302)
Indicators Of Compromise (IOC's) (304) that recognize different stages of an attack (i.e. based on frameworks such as this one: http://attack.mitre.org/)

Approach:
In some embodiments, the processor 104 is configured to utilize time-series analysis techniques (i.e. APT logic) to predict the next phase of an ongoing attack based on observed IOC's (304).

The third embodiment 300 may leverage external threat intelligence collected from a plurality of sources such as the use of external databases, accessed using a plurality of data access techniques and transmission protocols and/or through any data transmission mediums. External threat intelligence may also be collected by scraping the hacker community websites in different platforms such as the surface Web, D2web, and social media platforms.

### Fourth Embodiment of System 100

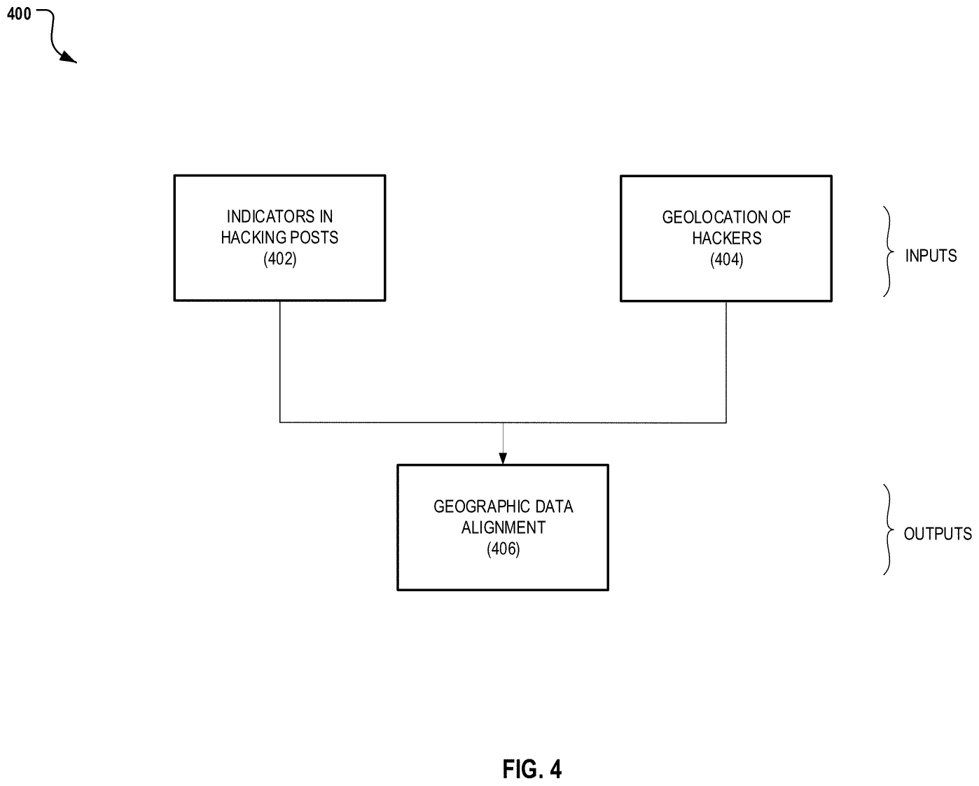

Referring to FIG. 4, in a fourth embodiment 400 of the system 100, the computing device 102, namely, the processor 104, is configured with computer-executable instructions for computing geographic data alignment (406). It is common to find some indicators in hacking posts (402) that help in approximating the geolocation of the hackers, such as language, geolocation coordinates in some social media platforms, named places in the post, and geolocation of source website. Such information may be aligned with the geolocation of network traffic (404) associated with hosts that have the vulnerability of vulnerable software. The geolocation of the traffic data can be identified based on the source that is generating the traffic (e.g., the geolocation of the source IP addresses). The defender may benefit from other details discussed in the group of hacking posts aligned to the traffic data. For example, if the posts are discussing attacks to certain software product, port numbers, or attack vector; the defender may prioritize their countermeasure accordingly.

For example, various Tweets may be found on Twitter, the common microblogging platform, where there are multiple users mentioning a CVE-2019-0708 (BlueKeep) or any of its related vulnerabilities. There is certain number of twitter users which notify the outcomes of the vulnerability and their exploits. Some of the posts are in the Russian language from which we can say that the source of the post or tweet is from Russia or somewhere in Europe.

### Fifth Embodiment of System 100

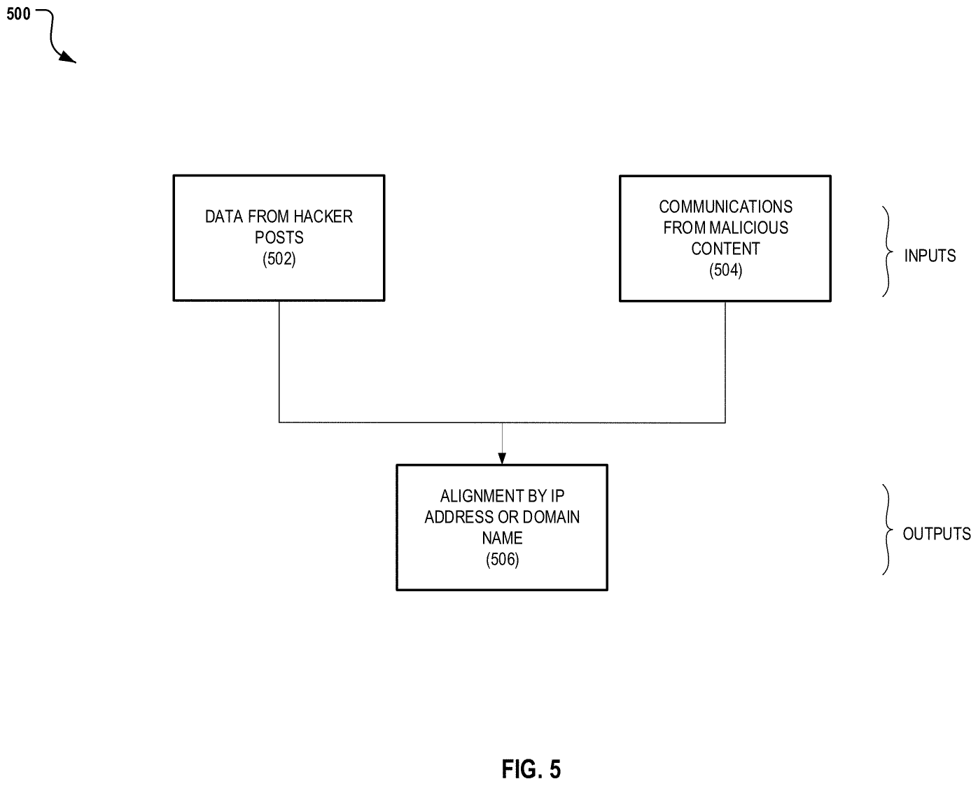

Referring to FIG. 5, in a fifth embodiment 500 of the system 100, the computing device 102, namely, the processor 104, is configured with computer-executable instructions for alignment by IP address or domain name (506). Like the fourth embodiment 400, the hacker posts (504) often mentioned IP address/domain names hosting malicious content (506). The defender may blacklist these IP address and domain names. Requests from and/or responses to and visits to such destinations may be identified from the historical traffic data to perform forensics and to understand the associated risk with such traffic from the context of the posts that reference malicious IP addresses and domain names. For example, a visit to an IP address i is observed on date d. These postings referenced the IP address:

Hacker forums in the Dark/Deep web data often mentions sites that provide or are instilled with malicious content. For example, aladel.net [37.48.65.148] is a phishing website which is mentioned in a lot of hacker mentions which installs an extension in the web browser which allows the malicious hacker to get control of the browser.

Take IP addresses and domain names extracted from hacker community intelligence and align them with external IP addresses communicating with hosts inside the enterprise. Then further augment with other stated methods to triage and identify malicious behavior. Further, allow for tagging, storage of labels, and training of ML models to afford better results.

### Sixth Embodiment of System 100

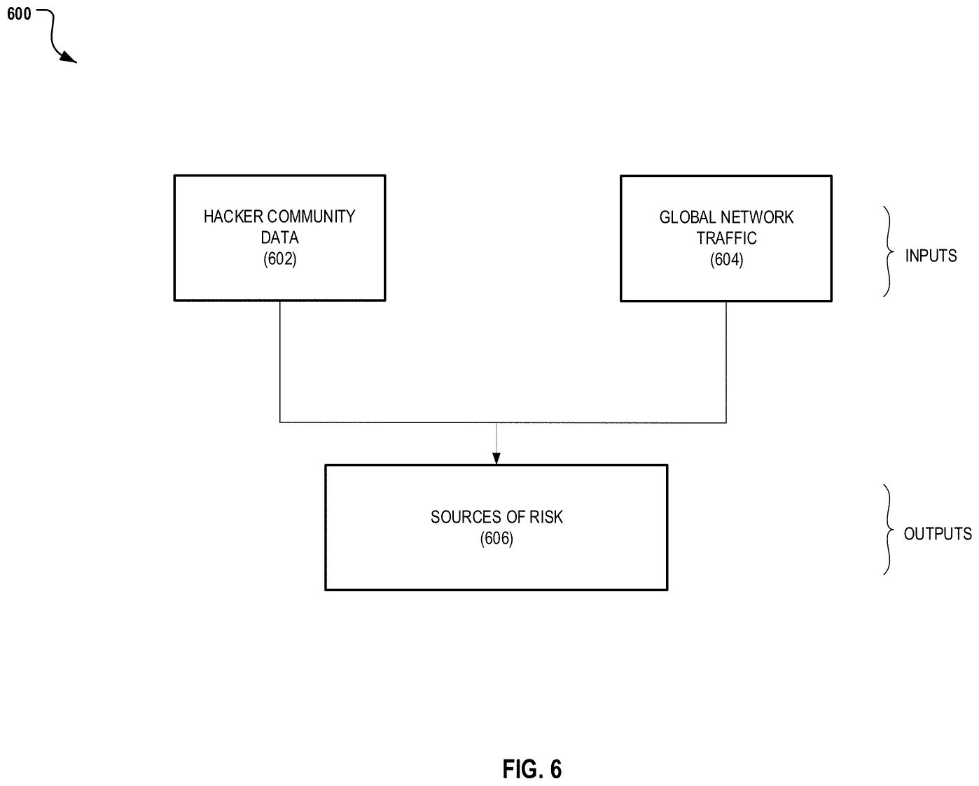

Referring to FIG. 6, in a sixth embodiment 600 of the system 100, the computing device 102, namely, the processor 104, is configured with computer-executable instructions for alignment of hacker community data (602) with global network traffic (604) for proactive identification of sources of risk (606). Threat intelligence platforms, such as GreyNoise.io, VirusTotal.com, and Shodan.io, record a large volume of global network traffic data and activity on millions of endpoints spread across the world. On the other hand, certain exploits are analyzed and discussed on the hacking community websites. Such analyses/discussions often explain what exploits do when they are successfully delivered. For example, this post mentioned a process named PowerShell or terminal that gets started after the exploit x (any exploit including BlueKeep, Dirty COW, or malicious files) is successfully deployed. Using a threat intelligence platform, that service is found to be associated with over m IP addresses and domain names. The defender may block traffic coming from and/or going to these sources/destinations.

As one example, a post was identified which talks about the ways and methods to detect BlueKeep vulnerability from a PCAP file. This post has some associated IP addresses which can be blacklisted for further communication.

Other data that might be aligned together to identify sources of risks:
File paths, e.g., /etc/passwd,
File names and extensions, e.g., .exe, .sh, .bin, .dll
Service name, e.g., rdp, ssh, https, http,
Service tasks, e.g., privilege escalation, new process created, deleting system files.
A chain of service activities, e.g., a file is created, a service is created, the service deletes some files, configures the server input sources, etc. emotnet (creates a backdoor on a vulnerable port(rdp) on a system)

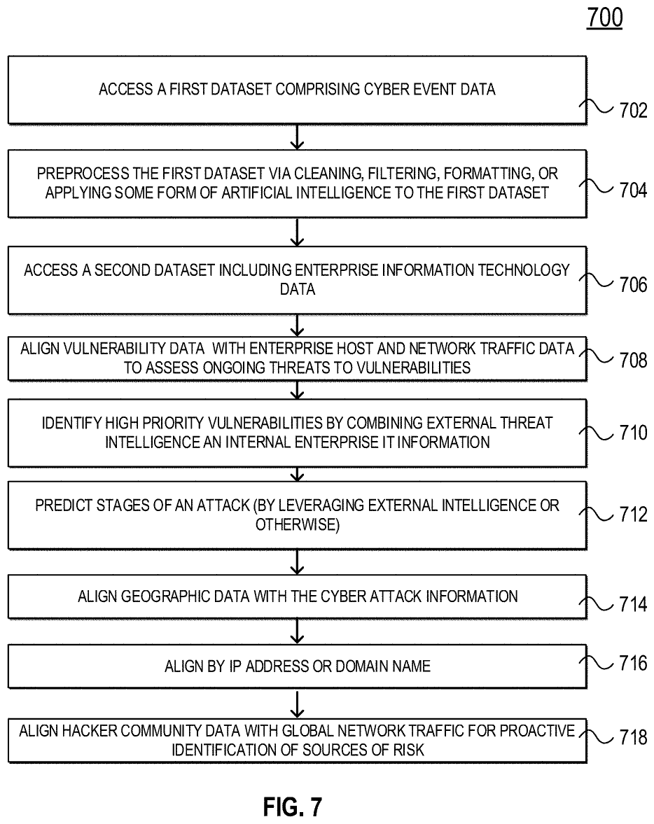

FIG. 7 is another exemplary computer-implemented process 700 executable by the computing device 102 for assessing software vulnerabilities through a combination of external threat intelligence and internal information technology data.

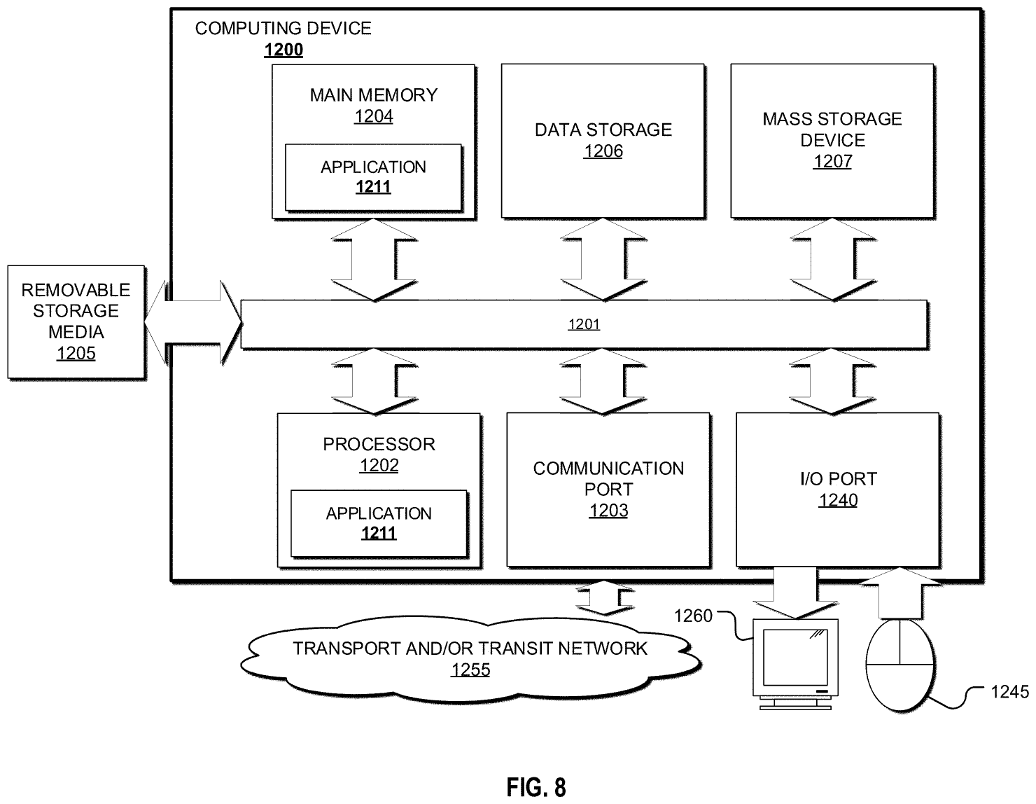

Referring to FIG. 8, a computing device 1200 is illustrated which may take the place of the computing device 102 or any computing devices leveraged to perform functionality described herein and be configured, via one or more of an application 1200 or computer-executable instructions, to execute for assessing various cyber risks as described. More particularly, in some embodiments, aspects of the methods herein may be translated to software or machine-level code, which may be installed to and/or executed by the computing device 1200 such that the computing device 1200 is configured for assessing software vulnerabilities through a combination of external threat intelligence and internal information technology data as described herein.

It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for assessing software vulnerabilities through a combination of external threat intelligence and internal information technology data, comprising:
accessing by a processor a first dataset comprising cyber event data;
preprocessing by the processor the first dataset to extract one or more vulnerability data parameters from the first dataset;
accessing a second dataset including enterprise information technology information from one or more devices associated with an enterprise; and
aligning by the processor the vulnerability data with enterprise host and network traffic data parameters from the enterprise information technology information to assess ongoing threats to vulnerabilities.

2. The method of claim 1, further comprising:
identifying by the processor high priority vulnerabilities associated with the enterprise by combining external threat intelligence defined by the vulnerability data with internal enterprise IT information defined by the enterprise information technology information.

3. The method of claim 1, further comprising:
predicting, by the processor, stages of an attack by:
inputting to the processor host or network data and indicators of compromise, and
applying time-series analysis to the host or network data to predict a next phase of an ongoing attack based on the indicators of compromise as observed.

4. The method of claim 3, further comprising leveraging external intelligence to predict the stages of the attack.

5. The method of claim 1, further comprising aligning geographic data, including:
identifying a hacker communication from the cyber event data, and
aligning the hacker communication with geolocation of network traffic from a source IP address associated with the hacker communication.

6. The method of claim 1, further comprising aligning by an IP address or domain name, including:
identifying a request an IP address associated with the deep or dark web from the cyber event data by conducting forensics by the processor to identify an IP address I observed on a data D referenced by a posting, and
aligning the IP address I with an external IP address communicating with hosts inside the enterprise.

7. The method of claim 1, further comprising aligning hacker community data with global network traffic for proactive identification of sources of risk to the enterprise technology infrastructure.

8. The method of claim 1, wherein the cyber event data any number or type of datasets, attributes, parameters, or other data structures associated with cyber-attack, hacker communications, geolocation information, network traffic logs, information from the NISD, information linking historical cyber events to specific vulnerabilities and associated hardware and software.
